(19) United States
(12) Patent Application Publication
(10) Pub. No.: US 2016/0125050 A1
(43) Pub. Date: May 5, 2016

(54) SYSTEM AND METHOD FOR GENERATING SEARCH REPORTS

(71) Applicant: Beacon Intellectual Property Services, LLC, Alexandria, VA (US)

(72) Inventors: Rahul Kumar, Delhi (IN); Niket Agrawal, Noida (IN)

(21) Appl. No.: 14/930,609

(22) Filed: Nov. 2, 2015

(30) Foreign Application Priority Data
Oct. 31, 2014 (IN) 3132/DEL/2014

(51) Int. Cl. G06F 17/30

(52) U.S. Cl. CPC G06F 17/30554; G06F 17/3053; G06F 17/30528; G06F 17/30867

(57) ABSTRACT

The present disclosure provides system and method for searching and analyzing information from a database based on a plurality of subject features. The system generates a list of relevant search results in a particular order and provides relevant excerpts from each of the search results in relation to each of the subject features, along with the association that represents the overlap between searched excerpt and the corresponding subject feature. The system may include a search report generator device that comprises a search module, a feature generation module, an analysis module, a ranking module, and a report generation module.

### CROSS-REFERENCE TO RELATED APPLICATIONS

This application is a non-provisional application which claims the benefit to Indian Patent Application Number 3132/DEL/2014 filed on Oct. 31, 2014.

### BACKGROUND

1. Field of the Invention

The subject matter described herein relates generally to search engine system and report generation. More particularly, the present disclosure relates to an apparatus and method for presenting search results and generating search reports. The present disclosure is applicable in a variety of field that requires presentation of data. Such fields may include, but are not limited to, business research, market research, patent research, and the like.

2. Description of Related Art

Search engines and search logics have been developing since the emergence of the Internet. A search engine generally conducts a search based on the user input and provides the results in certain order of relevancy. As such, the user runs through the search results provided by the system in the order that is generated without an option to customize. Moreover, a search result presented by the search engine lists relevant excerpts or headlines from the original data solely based on keywords inputted by the user. Often times, the excerpts does not accurately represent the original data.

Therefore, what is needed is a system and method that analyzes the data contextually and present the user a customizable search report and search results.

### SUMMARY

The subject matter of this application may involve, in some cases, interrelated products, alternative solutions to a particular problem, and/or a plurality of different uses of a single system or article.

In one aspect, a search report generator device is provided. The search report generator device may be in communication with one or more databases and may present search results to a user via a computerized user interface. The search report generator device may comprise one or more processors, a feature generation module, a search module, an analysis module, a ranking module, and a report generation module. Each components of the search report generator device may be in communication with one another via a network.

The feature generation module may identify a content from the one or more databases, where the content includes a key feature. The search criteria may comprise the key feature. The key feature may be determined by the search module based on a keyword, a classification, and a technical domain of the content. The search module may search the one or more databases based on the search criteria for a search result.

The analysis module may associate a status to the search result, where the status represents an association between the search result and the search criteria. The ranking module may assign a rank to the search result based on the association between the search result and the search criteria. Finally, the report generation module may present the search result, the status, the rank, and the search criteria to the user, in a report via the computerized user interface.

### BRIEF DESCRIPTION OF THE DRAWINGS

FIG. 1 provides an exemplary computerized user interface for uploading the content to the system.

FIG. 2 provides an exemplary embodiment of the feature generation and a computerized user interface presented by the system.

FIG. 3 provides an exemplary embodiment of the search result.

FIG. 4 provides an exemplary computerized user interface showing the customization options presented to the user by the system.

FIG. 5 provides an exemplary schematic of the system for presenting search results and generating search report.

### DESCRIPTION OF THE PRESENT DISCLOSURE

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

In the present disclosure, a system and method for presenting search results and generating search report from a database is provided. The system may comprise one or more processors, one or more databases, a web crawler, and one or more programs running on one or more processors. The components of the system may be integrated with a search report generator device which may be a standalone computing device. The one or more programs may comprise instruction that, when executed, presents a user a user-specific data analysis of the search results and search reports by employing the methods described herein. Additionally, the above mentioned system may further comprise a network where multiple users may have access thereto using a computing device. The system may be connected to the Internet.

It is to be noted that the presently disclosed system and method for presenting search results and generating search reports may utilized various available search engines to gather data. Similarly, the disclosed system and method may utilize available and various information sources to gather search results. In one embodiment, the information sources may include certain databases.

In referring to the description, specific details are set forth in order to provide a thorough understanding of the examples disclosed. In other instances, well-known methods, procedures, components, and materials have not been described in detail as not to unnecessarily lengthen the present disclosure.

It should be understood that if an element or part is referred herein as being “on”, “against”, “in communication with”, “connected to”, “attached to”, or “coupled to” another element or part, then it can be directly on, against, in communication with, connected, attached or coupled to the other element or part, or intervening elements or parts may be present. When used, the term “and/or”, includes any and all combinations of one or more of the associated listed items, if so provided.

The terminology used herein is for the purpose of describing particular embodiments only and is not intended to be limiting. As used herein, the singular forms “a”, “an”, and “the”, are intended to include the plural forms as well, unless the context clearly indicates otherwise. It should be further understood that the terms “includes” and/or “including”, when used in the present specification, specify the presence of stated features, integers, steps, operations, elements, and/or components, but do not preclude the presence or addition of one or more other features, integers, steps, operations, elements, components, and/or groups thereof not explicitly stated.

Various operations may be described as multiple discrete operations in turn, in a manner that may be helpful in understanding embodiments; however, the order of description should not be construed to imply that these operations are order dependent.

Spatially relative terms, such as “under” “beneath”, “below”, “lower”, “above”, “upper”, “proximal”, “distal”, and the like, may be used herein for ease of description and/or illustration to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable. Such descriptions are merely used to facilitate the discussion and are not intended to restrict the application of disclosed embodiments.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

Some embodiments of the present invention may be practiced on a computer system that includes, in general, one or a plurality of processors for processing information and instructions, RAM, for storing information and instructions, ROM, for storing static information and instructions, a database such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

The system may comprise one or more computers or computerized elements in communication working together to carry out the different functions of the system. The invention contemplated herein further may comprise non-transitory computer readable media configured to instruct a computer or computers to carry out the steps and functions of the system and method, as described herein.

The computers contemplated herein, may include, but are not limited to, desktop computers, laptop computers, tablet computers, handheld computers, smart phones and other cellular phones, and similar internet enabled mobile devices, digital cameras, a customized computing device configured to specifically carry out the methods contemplated in this disclosure, and the like.

The data and information contemplated herein, may include, but is not limited to text data, image data, audio date, video data, and the like.

The databases contemplated herein, may include, but are not limited to topic specific databases, information sources, and the like.

Generally, the following disclosure relates to an apparatus and method for presenting search results and generating search report gathered from a database. In addition, the present disclosure provides system and method for analyzing a data from a database based on a plurality of subject features and automatically generating a list of relevant search results in a particular user defined order, and providing relevant excerpts from each of the search results for each of the plurality of the subject features, along with a grade that represents the overlap between provided excerpt and the corresponding subject feature.

The system allows a user higher usability in reviewing the generated list of search results, selecting the search results suitable for the search report, editing the provided excerpts, editing the grades assigned to each feature for every search result, reviewing and defining the order of relevancy of the selected search result, and generating the search report.

The system for presenting search results and generating search report may comprise one or more computers or computerized elements, in communication with one another, working together to carry out the different functions of the system. The invention contemplated herein may further comprise a non-transitory computer readable media configured to instruct a computer or computers to carry out the steps and functions of the system and method, as described herein. In some embodiments, the communication among the one or more computer or the one or more processors alike, may support a plurality of encryption/decryption methods and mechanisms of various types of data.

The system may comprise a computerized user interface provided in one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any type of computerized interfaces known in the art capable of allowing a user to input data and receive a feedback therefrom. The computerized user interface may further provide outputs executed by the system contemplated herein.

Database and data contemplated herein may be in the format including, but are not limiting to, XML, JSON, CSV, binary, over any connection type: serial, Ethernet, etc. over any protocol: UDP, TCP, and the like.

Computer or computing device contemplated herein may include, but are not limited to, virtual systems, Cloud/remote systems, desktop computers, laptop computers, tablet computers, handheld computers, smartphones and other cellular phones, and similar internet enabled mobile devices, digital cameras, a customized computing device configured to specifically carry out the methods contemplated in this disclosure, and the like.

Network contemplated herein may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. Network may include multiple networks or sub-networks, each of which may include, for example, a wired or wireless data pathway. The network may include a circuit-switched voice network, a packet-switched data network, or any other network able to carry electronic communications. Examples include, but are not limited to, Picture Transfer Protocol (PTP) over Internet Protocol (IP), IP over Bluetooth, IP over WiFi, and PTP over IP networks (PTP/IP).

In one aspect, a method for presenting search results and generating search report is provided. The method may comprise a step of analyzing search results gathered from a database. The method beings with the system identifying a content based on which a search is conducted. The content may be uploaded by a user. The system further may create key features from the content and classify them as search criteria. The system may search for the key features from the database based on the search criteria. Once the search result is identified from the search, the system may further present the user the search results. A computerized user interface may be a portal for the user to access the search results. Each entry of the search results may be presented to the user showing an association between the entry and the key features. Further, the user may utilize the computerized user interface to customize the search result and to select the entry of the user's choice. The number of key features may be any number from single feature to multiple features.

In another aspect, a method for generating the search report from the user selected entry of search results is provided. The search results may be provided to the user by the system according to the search criteria. Each of the user selected entry of search results may be indicated with the status of the search criteria. The search report may contain search results entry selected by the user. The computerized user interface may provide the user to select each entry of the search results that the user likes to include in the search report. Once selections are made by the user, the search report may be provided to the user.

The content may include, but are not limited to, text, disclosure, document identifier (such as a patent), web link, local file or key feature to be searched, and a document image.

The key features may be created by the system based on the keywords, classifications, and technical categories contained therein. The key features also may be generated and uploaded by the user directly to the system, as such the key features may be predetermined prior to beginning the search. Each of the key features may form a part of search criteria from which the search is conducted. Examples of the search criteria may include, but are not limited to, steps, methods, partial description of the content, keywords, statement, and similar information.

In some embodiments, the search criteria may further comprise a restriction to the search. Examples of such restriction may include, but are not limited to time period, publication date, filing date, jurisdiction, location, country, assignee, owner, author, publisher, classification, categories, types of data (news, patents, blogs, instruction, etc.), and the like. The search may be conducted based on the search criteria that includes the search restriction, as such the search result may eliminate any search results based on the search restriction applied.

Once the key features and the search criteria are set the system may begin to search in the database. The database may include an internet and any other network-enabled databases.

In some embodiments, the search results may be presented to the user via the computerized user interface individually or collectively.

In some embodiment, the search results may be presented to the user in a search report format via the computerized user interface.

In some embodiments, the status of the search criteria or the status of the key features assigned to each entry of the search results may indicate an association between the key features and the search results. By way of example, the status may inform the user whether the key feature (or the search criteria) is present fully, present partially, or not present. The system may automatically generate such assignment of status to each entry of the search results by analyzing the original data gathered by the system. The original data gathered by the system (the search result) may be analyzed to determine the level of association between the search result and the key feature, for example a similarity between the search result and the key feature may be represented by the status.

In some embodiments, the status may present the user an excerpt from the original data. Such excerpt may be any type of data such as image, sound, text, and the like. Methods for identifying the excerpts from the original data are well known in the field of art.

In some embodiments, the status may provide the user with reasons of such status assignment. By way of example, the status of “present partially” may be assigned to the entry of the search results in relation to the key feature, when synonyms to the keywords generated from the content is present in the entry. Other reasons include closeness in the field of technology being searched, and other categories of search criteria's equivalents.

The user may customize the search report. In one embodiment, the user may edit the key features which includes adding and deleting. In another embodiment, the user may change the order of the search results. In yet another embodiment, the user may update the status manually.

The user also may customize the template of the search report. In one embodiment, the user may load user preferred report templates or modify the existing search report templates.

The search reports may be communicated to the user via various communication methods. Person having ordinary skill in the art would understand the various communication methods.

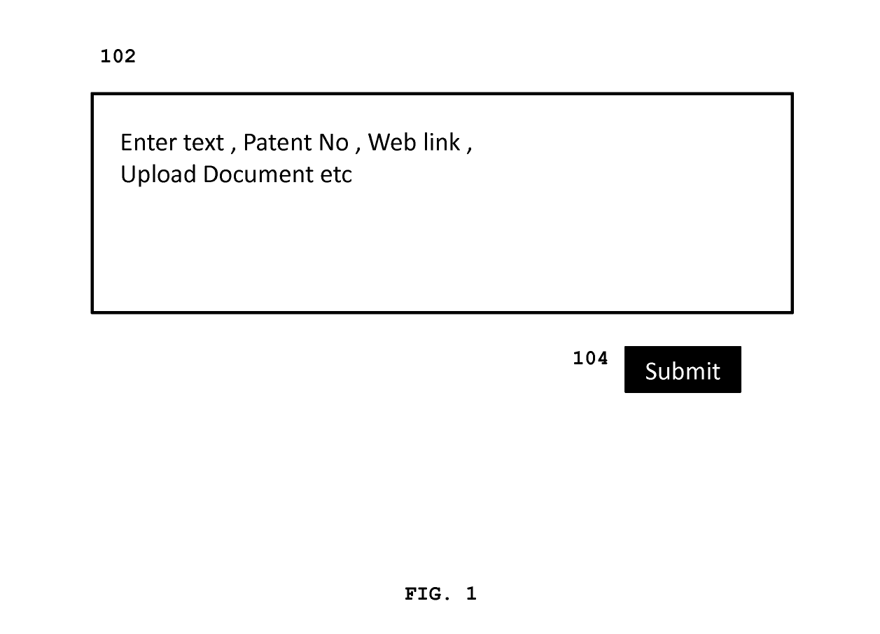

Now turning to FIG. 1, FIG. 1 provides an exemplary computerized user interface for uploading the content to the system. The user can upload the content 102, which can be in the form of a simple text, document identifier (like patent number), web link, file or document, or subject features to be searched. A “submit” GUI may be provided for submitting the content.

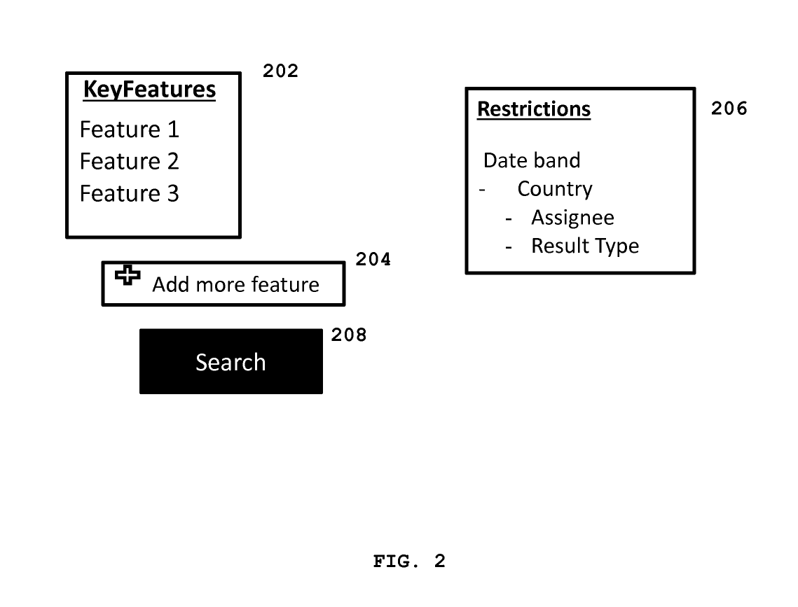

FIG. 2 illustrates an exemplary embodiment of the feature generation and the computerized user interface presented by the system. In this embodiment, the key features 202 and the restrictions 206 (search criteria) are shown. The system generates the key features 202 from the search results which was conducted based on the content and the search criteria. The system may create key features 202 based on the keywords, classification codes, area of work, and the like, obtained from the content provided by the user. The key features 202 can be edited and/or deleted by the user. The user can also provide additional key features manually via the “add more feature” GUI 204. Similarly, the user can customize the status and the search criteria by providing additional search criteria, such as filling or publication date range, publication country, assignee, inventor, classification codes, document type, and the like.

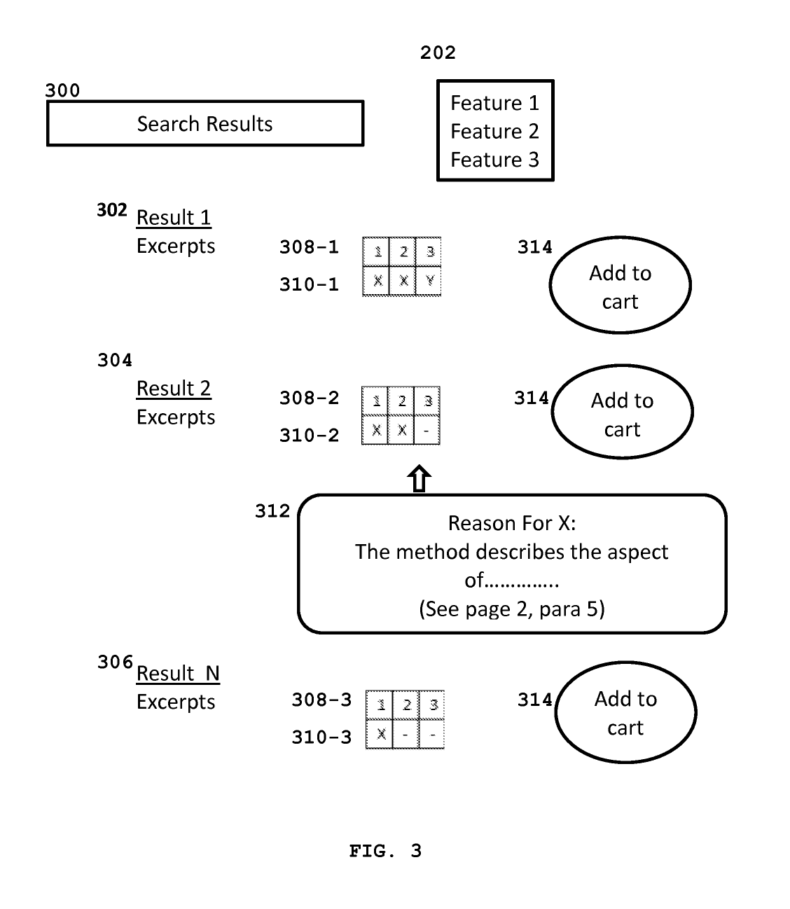

FIG. 3 illustrates an exemplary embodiment of the search result. The search result may be presented through a computerized user interface showing the status of the key features. The reasons for the assigned status may also be presented. The system may generate and present a list of search results 302 304 306. The search results 302 304 206 may be presented in a particular user defined order. For every search result entry 302 304 306, relevant excerpts from the searched information may be provided corresponding to every key features 202, along with the status 310-1 310-2 310-3 (herein after referred to as 310) that represents the relation between the excerpts and the corresponding key features 308-1 308-2 308-3 (hereinafter referred to as 308). The user can review the excerpts, the assigned status 310, and the reason 312 for allocation of the status, provided by the system via the computerized user interface. The user can select and move the search results of interest to the report cart 314, which indicates that the search result entry 302 304 306 is selected and will be included in the search report. The status may represent an association between the search result and the search criteria (for example, key features 308). The status may be indicated by predefined indicators. In this embodiment, the “X”s indicate the status of “present fully” and the “Y”s indicate the status of “present partially”. In the case of no relation between the search result and the key features the status indication may be simply left blank.

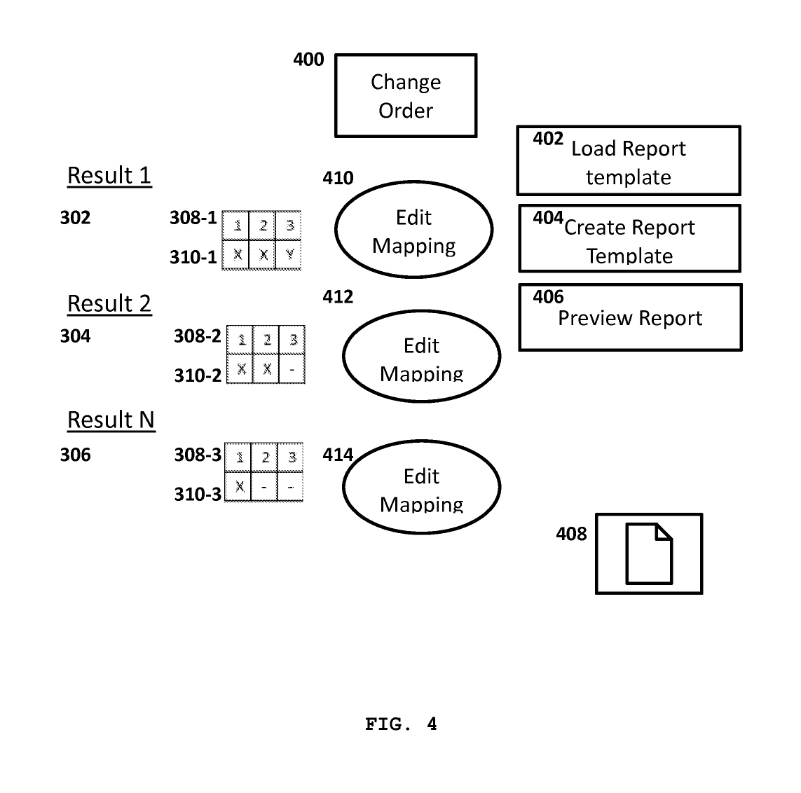

FIG. 4 illustrates an exemplary computerized user interface showing the customization options presented to the user by the system. The user can customize the order of the search results 302 304 306 in the report by selecting “change order” GUI 400. By way of example, the weights can be assigned to each of the key features, and the order can be based on the overall score calculated based on the weights and the status 310 assigned to each of the features 308. The search report cart can be reviewed at any point in time by the user. In the search report cart, the user can review the selected list of search results, edit the provided excerpts, edit the status assigned to each key feature for every search result, edit the weights given to the search result entry, and review and define the order of the selected search results. The edits may be performed by selecting the GUI “edit mapping” 410 412 414, respectively provided to each of the search results 302 304 306. Finally, the system may generate the search report. The user can preview 406 the generated report, save it 408, download, and/or email the final report. The user can configure the report template, or the default template can be modified 402 404. These and other activities may be provided via the computerized user interface controlled by the system presented herein.

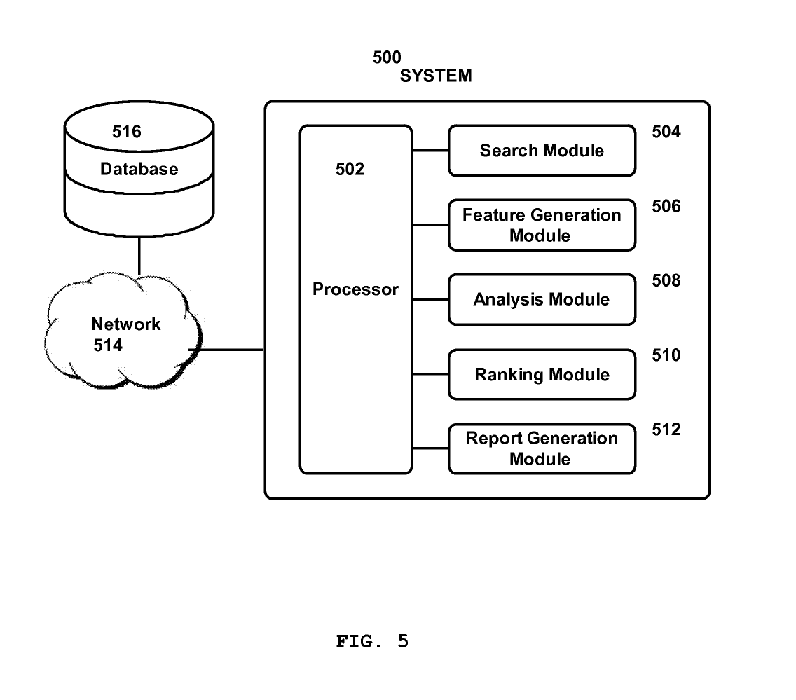

FIG. 5 provides an exemplary schematic of the system for presenting search results and generating search report. This exemplary system may utilize the method and system provided herein. The system 500 may comprise a processor 502 which may be in communication with a search module 504, a feature generation module 506, an analysis module 508, a ranking module 510, and a report generation module 512. The system 500 may further be in communication with the database 516 via a network 514, such as the internet.

The search module 504 may search for relevant information based on the user inputted content from one or more databases 516. From the content, the feature generation module 506 may identify the key features form the content. In addition, the search criteria may be identified by the feature generation module 506. The analysis module 508 may further examine the search result entries and associate the status to the search result in relation to the key features being searched. Once the analysis is conducted to the search results, the search results may be further ranked by the ranking module 510 based on the weights and the status (closeness of the search results entry to the criteria). Once the user optionally customizes the search results, the report generation module 512 may deliver the search report to the user via the network 514 using various communication methods. The search results may be provided to the user via the computerized user interface (not shown).

In conclusion, a search report generator device is provided. The search report generator device may be in communication with one or more databases and may present search results to a user via a computerized user interface. The search report generator device may comprise one or more processors, a feature generation module, a search module, an analysis module, a ranking module, and a report generation module. Each components of the search report generator device may be in communication with one another via a network.

The feature generation module may identify a content from the one or more databases, where the content includes a key feature. The search criteria may comprise the key feature. The key feature may be determined by the search module based on a keyword, a classification, and a technical domain of the content. The search module may search the one or more databases based on the search criteria for a search result.

The analysis module may associate a status to the search result, where the status represents an association between the search result and the search criteria. The ranking module may assign a rank to the search result based on the association between the search result and the search criteria. Finally, the report generation module may present the search result, the status, the rank, and the search criteria to the user, in a report via the computerized user interface.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled. in. the art will readily observe that numerous modifications, applications and alterations of the device and method may be made while retaining the teachings of the present invention.

What is claimed is:

1. A search report generator device, in communication with one or more databases, that presents search results to a user via a computerized user interface, comprising:
one or more processors in communication with each other via a network, the one or more processors in communication with the one or more databases;
a feature generation module, in communication with the one or more processor, identifying a content from the one or more databases, wherein the content includes a key feature, a search criteria comprising the key feature, the key feature being determined by the search module based on a keyword, a classification, and a technical domain of the content;
a search module, in communication with the one or more processors, searching the one or more databases based on the search criteria for a search result;
an analysis module, in communication with the one or more processors, associating a status to the search result, the status representing an association between the search result and the search criteria;
a ranking module, in communication with the one or more processors, assigning a rank to the search result based on the association between the search result and the search criteria; and
a report generation module, in communication with the one or more processors, presenting the search result, the status, the rank, and the search criteria, in a report via the computerized user interface.

2. The search report generator device of claim 1, wherein the content is selected from the group consisting of text, written disclosure, document identifier, web link, and image.

3. The search report generator device of claim 1, wherein the search criteria further comprises a search restriction, the search restriction limiting the scope of the search being conducted by the search module.

4. The search report generator device of claim 3, wherein the search restriction is selected from the group consisting of content creation date, content publication date, jurisdiction, country, language, and author.

5. The search report generator device of claim 1, wherein the key feature is predetermined prior to the search module begins the search.

6. The search report generator device of claim 1, wherein the one or more processors is operating on a server in communication with the one or more databases via the network.

7. The search report generator device of claim 1 further comprising a web crawler controlled by the search module, the web crawler searching the one or more databases that includes the internet.

8. A method for generating a search report, using a search report generator device in communication with one or more databases, that presents a search result to a user via a computerized user interface, the one or more databases in communication with one or more processors via a network, comprising the steps of:
identifying, with a feature generation module in communication with the one or more processors, a content from the one or more databases, wherein the content includes a key feature, a search criteria comprising the key feature, the key feature being determined by the search module based on a keyword, a classification, and a technical domain of the content;
searching, with a search module in communication with the one or more processors, the one or more databases based on the search criteria for the search result;
associating, with an analysis module in communication with the one or more processors, a status to the search result, the status representing an association between the search result and the search criteria;
assigning, with a ranking module in communication with the one or more processors, a rank to the search result based on the association between the search result and the search criteria; and
presenting, with a report generation module in communication with the one or more processors, the search result, the status, the rank, and the search criteria to the user via the computerized user interface.

9. The method of claim 8, wherein the content is selected from the group consisting of text, written disclosure, document identifier, web link, and image.

10. The method of claim 8, wherein the search criteria further comprises a search restriction, the search restriction limiting the scope of the search being conducted by the search module.

11. The method of claim 10, wherein the search restriction is selected from the group consisting of content creation date, content publication date, jurisdiction, country, language, and author.

12. The method of claim 8, wherein the key feature is predetermined prior to the step of searching by the search module.

13. The method of claim 8, wherein the one or more processors is operating on a server in communication with the one or more databases via the network.

14. The method of claim 8, wherein the one or more processors is operated by a computing device having the one or more databases integrated therein.

15. A non-transitory computer readable medium storing executable instructions which, when executed, cause one or more processors to perform the following steps for generating a search report, using a search report generator device in communication with one or more databases, that presents a search result to a user via a computerized user interface, the one or more databases in communication with one or more processors via a network, the steps comprising:
identifying, with a feature generation module in communication with the one or more processors, a content from the one or more databases, wherein the content includes a key feature, a search criteria comprising the key feature, the key feature being determined by the search module based on a keyword, a classification, and a technical domain of the content;
searching, with a search module in communication with the one or more processors, the one or more databases based on the search criteria for the search result;
associating, with an analysis module in communication with the one or more processors, a status to the search result, the status representing an association between the search result and the search criteria;
assigning, with a ranking module in communication with the one or more processors, a rank to the search result based on the association between the search result and the search criteria; and
presenting, with a report generation module in communication with the one or more processors, the search result, the status, the rank, and the search criteria to the user via the computerized user interface.

16. The method of claim 15, wherein the content is selected from the group consisting of text, written disclosure, document identifier, web link, and image.

17. The method of claim 15, wherein the search criteria further comprises a search restriction, the search restriction limiting the scope of the search being conducted by the search module.

18. The method of claim 17, wherein the search restriction is selected from the group consisting of content creation date, content publication date, jurisdiction, country, language, and author.

19. The method of claim 15, wherein the key feature is predetermined prior to the step of searching by the search module.

20. The method of claim 15, wherein the one or more processors is operating on a server in communication with the one or more databases via the network.
